(19) United States
(12) Patent Application Publication
(10) Pub. No.: US 2020/0055220 A1
(43) Pub. Date: Feb. 20, 2020

(54) METHOD AND DEVICE FOR INJECTION OVERMOULDING

(71) Applicant: AISAPACK HOLDING SA, Vouvry (CH)

(72) Inventor: Etienne HERMANT, Chalons en Champagne (FR)

(73) Assignee: AisaPack Holding SA, Vouvry (CH)

(21) Appl. No.: 16/342,399

(22) PCT Filed: Oct. 17, 2017
(86) PCT No.: PCT/IB2017/056430

§ 371 Date: Apr. 16, 2019

(30) Foreign Application Priority Data
Oct. 18, 2016 (EP) 16194459.0

(51) Int. Cl. B29C 45/26; B29C 45/14; B29C 45/76; B29C 45/00

(52) U.S. Cl. CPC B29C 45/26; B29C 45/14; B29C 45/768; B29C 2945/76461; B29C 2045/2687; B29C 2945/76163; B29C 2945/7629; B29C 45/0055

(57) ABSTRACT

The invention concerns an injection overmoulding device comprising at least one indexed rotary turret on which cooled moulds are installed, each mould comprising a plurality of cavities, and at least five stationary stations arranged around said turret, including at least a first station, a second station and a third station that are used, respectively, for carrying out the operations of positioning the inserts in the cavities of the mould, injecting plastic material into the cavities of the mould, and demoulding the at least partially cooled objects. The device comprises, for each mould, at least separate injection means. The invention also concerns a method implemented by the device.

The present application claims priority over the prior European application no. 16194459.0 filed on 18 Oct. 2016 in the name of AISAPACK HOLDING S.A., the contents of this prior application being incorporated in its entirety by way of reference in the present application.

### TECHNICAL FIELD AND PRIOR ART

The present invention relates to the field of manufacturing a multi-component plastics object by overmolding an insert which has been previously arranged in the injection mold. More specifically, the subject of the invention relates to a method and a device for overmolding, comprising an indexed rotary turret on which injection molds are arranged, and stationary stations which are arranged around the turret and which interact with the molds.

The method and devices for injection-molding comprising molds which are arranged on an indexed rotary platform are disclosed in the prior art, in order to mold objects made of injected thermoplastic material. For example, the patent FR 7832832 discloses a rotary device with a first station consisting in injecting the material into the cavity of the mold and a second station consisting in compacting the material using a compression bar introduced into the mold gate. The object is then cooled and then demolded. The patent FR 7832832 discloses a method and an indexed rotary device comprising two stations and one mold per station. This method and this device are not suitable for carrying out overmolding operations, the positioning of the insert in the cavity of the mold being difficult given the configuration of the device. This device also does not permit the production of molded objects at a high production rate since the compacting of the material in the cavity of the mold during the cooling of the part is carried out at the second station when the turret is stopped.

The U.S. Pat. No. 6,461,558 discloses a method and a rotary molding device for encapsulating integrated circuits. The proposed molding device comprises an indexed turret, presses being arranged thereon. The device also comprises stationary stations which are arranged around the turret in order to load the inserts into the cavity of the molds; in order to supply the molded material; and in order to unload the objects. In the U.S. Pat. No. 6,461,558 the pressing means are installed on the turret in addition to transfer pots which significantly increases the mass of the turret and as a result its inertia. This type of device, which is well-suited to molding at a low production rate, does not permit molding at a high production rate due to its inertia. The device disclosed in the U.S. Pat. No. 6,461,558 is also designed for the transformation of thermosetting resins which contract in hot molds. However, this device is not provided for molding objects made of thermoplastic resin. This device may not be used for thermoplastic resins which require a heating phase prior to being injected into the mold and a cooling phase in cooled molds in order to set and take the shape of the object. This device also has the drawback of having pressing means installed on the turret which involves a number of presses which is equal to the number of molds and, as a result, a high installed mass which considerably increases the inertia of the turret and has a negative impact on the cycle time.

The patent application DE19901114 discloses a molding machine comprising a turret with intermittent rotation, bearing a plurality of molds and stations arranged around the turret. The molding machine, in particular, comprises a station for injecting which is provided with a press and a station for unloading the molded objects. According to the patent application DE19901114 the press is arranged outside the turret and has means for displacing the molds between the turret and the molding station and between the turret and the station for unloading. The patent application DE19901114 has the advantage of not installing forced means for closing the mold and, as a result, reducing the inertia of the turret. However, this patent application has the drawback which is associated with the handling of the mold between the turret and the pressing station and between the turret and the station for unloading. The proposed method is not suitable for molding in multi-cavity tools produced at a high rate. The handling of the mold requires the connection and disconnection of the cooling circuit of the mold each time it is handled, which is not compatible with high production rates.

### Definitions

In the present application, “installed means” is understood as means fixed to the turret and, as a result, activated by an indexed rotational movement.

In contrast, “stationary means” is understood as the means which are not fixed to the turret but arranged around the turret. The so-called “stationary” means generally comprise moving parts, such as for example means for positioning the inserts, means for unloading the objects or even the injection means.

### SUMMARY OF THE INVENTION

An object of the invention is to propose an indexed rotary overmolding device and a molding method implemented by the device which are improved relative to those known from the prior art.

More specifically, an object of the invention is to proposed a device and a method for indexed rotary overmolding which enables the aforementioned drawbacks of the prior art to be remedied. The present invention is particularly suitable for manufacturing at a high production rate objects requiring at least one overmolding operation.

The overmolding device according to the invention, in particular, comprises an indexed rotary turret on which cooled molds are installed and at least five stationary stations arranged around said turret. On the five stations, at least three stations are used to carry out the following operations:
positioning the inserts in the cavities of the mold,
injecting plastic material into the cavities of the mold,
demolding the at least partially cooled objects.

The two further remaining stations may be used to increase the cooling time or to carry out monitoring operations or to carry out operations for actuating the molds or even to carry out operations on the inserts and/or on the molded objects.

According to a preferred embodiment, the turret may comprise a number of stations of between five and eight.

According to one embodiment of the invention, the number of molds arranged on the turret is preferably equal to the number of stations. The number of multi-cavity molds arranged on the turret is at least five and is preferably between five and eight.

In order to permit the production of overmolded parts at a high rate, the molds arranged on the turret comprise a plurality of cavities. According to the invention, the number of cavities per mold is, for example, between four and thirty two and preferably between four and sixteen. The maximum number of cavities per mold is based on the complexity of handling and overmolding a greater number of inserts.

In one embodiment, a first feature of the invention is that the number of shooting pots is equal to the number of cavities per mold. This means that during the injection phase each cavity of the mold is connected to a separate shooting pot. This embodiment permits each cavity to be filled separately from the adjacent cavities. The proposed method of filling is particularly advantageous for overmolding inserts at a high production rate.

The separate filling of each cavity permits the drawbacks of overmolding inserts in a multi-cavity mold to be remedied.

The invention makes it possible, in particular, to remedy the drawbacks associated with the absence of an insert from one of the cavities. In particular, if an insert is absent from one of the cavities at the moment of injection the cavity without an insert is not filled, without this having an influence on the quality of the parts produced in the other cavities. In a conventional injection system where all of the cavities are filled simultaneously, the absence of an insert from one of the cavities has the result of producing defective parts since the filling of the mold bodies is no longer carried out evenly. Moreover, in a conventional injection system the uneven filling of the mold bodies often causes difficulties in the ejection of the parts, which causes stoppages in the production in order to extract the incomplete parts manually from the mold. The invention makes it possible to remedy this loss of productivity by not filling the cavity when the insert is absent and, as a result, by avoiding uneven filling and its negative consequences for productivity which have to be avoided in a process at a high production rate.

According to one embodiment of the invention, the use of a device for detecting the presence of inserts in the cavities of the mold makes it possible to define the cavities to be filled before the injection step. Such a device for detecting inserts is preferably positioned outside the mold. This device for detecting carries out a monitoring operation after the positioning of the inserts and before the closing of the mold. Preferably, the system for detecting is a visual device (for example optical or a camera) coupled to an image analysis module. According to one embodiment, the invention permits only cavities in which an insert is detected to be filled. One advantage of this method is that since the operations are carried out on an indexed rotary system, the detecting operation may be carried out in masked time without this affecting the production rate of the machine. For example, a station for detecting inserts may be located between the station for positioning the inserts and the station for injecting. According to a further embodiment, the detection of the inserts is carried out during the rotation of the turret.

A further advantage of the separate filling of the cavities is to permit the use of less accurate inserts in terms of dimensions. The dimensional variations of the inserts may influence the volume occupied by each insert in the cavity of the mold. This results in a variable volume of resin injected into each mold body. When the dimensional variations of the inserts are not negligible relative to the volume of injected material, in a conventional multi-cavity injection system this results in uneven filling of the mold bodies and as a result significant dimensional variations of the objects molded or the appearance of flash on the molded objects. Due to the separate filling of the cavities, the invention enables the use of inaccurate inserts, whilst preserving a high level of accuracy in terms of the molded part of the object. The use of less accurate inserts makes it possible in certain cases to reduce the cost of the parts produced. The invention makes it possible to remedy the problems of flash on the molded objects and thus reduce the number of rejects.

A further advantage of the separate filling of the cavities is associated with the rejection of inserts which are poorly positioned in the cavity of the mold. The separate injection of the cavities coupled with the system for monitoring the position of each insert in the cavity of the mold makes it possible not to fill the cavities in which the positioning of the insert is out of tolerance. The principle used in conventional systems consists in injecting resin into all of the cavities and then ejecting the defective parts. This method generates significant wastage which is inherently difficult to recycle and is inefficient since defective objects are manufactured.

The invention makes it possible to overcome this drawback. In many cases the ejected inserts may be reused (possibly after correction), otherwise the recycling thereof is facilitated since the overmolding operation has not taken place.

A further advantage of the separate filling of the cavities is associated with the flexibility provided by this injection method. For example, the invention permits parts of different mass to be produced by overmolding. This is particularly advantageous in order to produce simultaneously different products designed to be packaged together (for example a range of screwdrivers with sleeves of different sizes). The production flow is significantly improved since the packaging of the manufactured products may be made in-line directly after the overmolding operation, without storage of the products, in contrast to the conventional production method or a single type of product may be produced at the same time on the same machine.

A further advantage of the separate filling of the cavities is associated with the maintenance operations of said cavities. In the case of a conventional multi-cavity device for injection overmolding, when a cavity is defective and requires a maintenance operation it is necessary to stop the production which is in progress in order to avoid too great a number of rejects. By means of the invention, the defective cavity is identified and deactivated so that it is no longer used. This operating method makes it possible to complete production using other cavities and to carry out the maintenance of said defective cavity during production or thereafter. The invention thus makes it possible to carry out production without interruption even if a cavity becomes defective accidentally during a production cycle.

A further advantage of the separate filling of the cavities is associated with the possibility of eliminating sprue in the multi-cavity molds without hot channels.

The invention is particularly advantageous for overmolding fragile inserts which requires the use of a low pressure and temperature of the resin injected during the filling of the cavities. The separate filling of the cavities permits the optimal reduction of the temperature and injection pressure.

In one embodiment, the invention is also characterized in that each mold has separate means for locking. The separate means for locking makes it possible to carry out the cooling and the compacting of the objects outside the station for injecting. This embodiment is particularly advantageous since it permits the cycle time to be optimized and high production rates to be achieved.

The means for locking make it possible to keep the mold closed after the filling of the cavities and the releasing of the forced means for closing the mold. The means for locking make it possible to keep the mold closed during the rotation of the turret and during the cooling of the object in the cavity of the mold.

The means for locking are composed of a lock and an energy accumulation mechanism. The lock is, for example, a hook system or an expansion system or even a deformation system. The energy accumulation system makes it possible to maintain a significant closing force between the two parts of the mold during the cooling of the object. The energy accumulation mechanism is composed, for example, of mechanical springs or pneumatic springs, or hydraulic springs. The actuation of the lock may be carried out by an actuator of the pneumatic, hydraulic or electric type. The actuation of the lock is either stationary or installed on the turret. Preferably, the actuation is installed on the turret in order to permit the unlocking of the mold during the rotation of the turret.

In one embodiment, the invention is further characterized in that compacting means which are separate from the injection unit are used. In the description of the invention, the expression “compacting means” denotes the means which exert a pressure on the resin injected during the cooling phase. The compacting phase makes it possible, in particular, to avoid shrink marks in the molded objects or to improve the dimensional stability in addition to the accuracy of the molded parts.

According to one embodiment of the invention, each cavity has separate compacting means installed on the turret. Thus the number of compacting means is equal to the total number of cavities on the turret, i.e. the number of cavities per mold multiplied by the number of molds on the turret. According to the invention, the number of compacting means per mold is between four and thirty two and preferably between four and sixteen.

An advantage of the invention results from the fact that the compacting means are installed on the turret. This makes it possible to maintain a pressure on the injected resin during the entire cooling of the object in the mold. The fact that the compacting means are installed also makes it possible to maintain the pressure on the injected resin without having a negative impact on the production rate.

The compacting means comprise at least one mobile tool part entering into the cavity and exerting a pressure on the injected resin, in addition to a compacting element which is connected to the mobile tool part.

Preferably, the compacting element is a passive element such as a spring. According to an embodiment of the invention, the compacting element accumulates energy during the filling of the mold body when the cavity is connected to the shooting pot (compression of the spring). A part of the energy accumulated during the filling phase is then restored by the compacting element during the cooling of the object (decompression of the spring, for example). The passive compacting element may be a spring made of steel or an air spring or compressible element such as an elastomer or a further equivalent means.

According to a further embodiment, the compacting element is an active element such as an actuator. The active compacting element makes it possible to control the compacting pressure over time, but increases the inertia installed on the turret.

In a conventional method for multi-cavity injection overmolding, the compacting phase is limited by the time for the solidification of the injection gate. After the solidification of the gate, the pressure exerted by the injection unit no longer has an effect on the molded object. Moreover, a significant disparity in the solidification time of the gate is observed between the mold bodies, which has the effect of increasing the variations between the molded objects. The invention makes it possible to remedy these difficulties: it makes it possible to exert a pressure on the molded object during the entire cooling phase in the mold, even if the injection gate is solidified. The dimensional accuracy of the objects is also improved by this method.

The separate compacting means makes it possible to optimize the pressure exerted in each individual cavity during the cooling phase. This makes it possible to use, in particular, less accurate inserts or to mold parts of different volumes without compromising the quality of the objects obtained.

The invention is particularly advantageous for the overmolding of fragile inserts requiring the reduction of the pressure on the insert during the overmolding operation. The separate compacting means for each cavity permits the optimal reduction and adjustment of the compacting pressure on the overmolded inserts.

In one embodiment, the method according to the invention comprises at least the following successive operations:
positioning the inserts in the mold
monitoring the presence and the position of the inserts in each cavity
closing the mold
locking and forced closing of the mold
starting the injection
ending the injection
solidification of the gate
releasing the forced closing of the mold
starting the compacting
cooling
unlocking the mold, ending the compacting
opening the mold
unloading the molded objects with their insert.

According to the invention, the hot melt supply channels are entirely separated from the cooled molds installed on the turret. In the invention, the hot part of the tool which permits the supply of melt into the cavities of the mold is preferably connected to the stationary station for injecting. The separation of the hot part and the cold part of the tool makes it possible to improve the efficiency of the cooling of the molds and to reduce their installed mass. The hot part of the tool is connected to the stationary station for injecting; the cold part of the tool is connected to the turret and constitutes what is called the mold in the invention.

In one embodiment, the invention proposes a method and a device for injection overmolding with low inertia, making it possible to achieve high production rates. According to one embodiment of the invention, the method and the device comprise means for forced closing of the mold which are stationary and act only during the phase of injecting the plastic material into the mold and until the moment of solidification of the injection gate. These forced means for closing guarantee the closing and the seal of the mold during the filling of the mold. According to a preferred embodiment, each cavity of the mold comprises separate forced means for closing.

According to one embodiment of the invention, the method and device for injection overmolding permit the compacting of the injected material during the cooling of the molded part in the cavities. According to one embodiment of the invention, the method and the device comprise means for locking and unlocking the mold in addition to compacting means installed on the turret. According to one embodiment of the invention, each mold has separate means for locking and each cavity has separate compacting means. According to a preferred embodiment, the compacting means are passive.

The present invention permits the opening and closing of the mold during the rotation of the turret in order to optimize the cycle time. According to one embodiment of the invention, the method and the device comprise means for opening and closing installed on the turret. These means take up little space and are rapid due to the low mass of the molds.

The invention makes it possible to reduce the complexity of robotic operations. These robotic operations are useful, in particular, on the station for loading inserts in order to position simultaneously a plurality of inserts in the mold. The proposed method for injection overmolding makes it possible to reduce by a factor of 4 to 10 the number of inserts handled simultaneously relative to a conventional injection method having the same number of cavities. This is in addition to the fact that the mold arrives open from the station for unloading which makes it possible to arrange stationary insertion means between the upper part and lower part of the mold. According to a preferred embodiment of the invention, the upper or lower part of the mold combines a movement perpendicular to the movement of opening in order to release the upper part from the lower part and facilitate the handling in the mold. This perpendicular movement, preferably along the radial axis of the turret, permits the handling of bulky inserts and facilitates the optional operations of monitoring, assembly, welding or printing in the mold. The operations of unloading the objects are also considerably facilitated.

The invention permits the optional addition of further stationary stations around the indexed rotary turret. The invention permits, for example, the addition of a station for monitoring the presence and the position of an insert in each cavity. Further stations may be added, such as for example stations for printing, assembly, dimensional monitoring or welding.

In one embodiment, the invention relates to a device for injection overmolding, comprising at least one indexed rotary turret on which cooled molds are installed, each mold comprising a plurality of cavities and at least five stationary stations arranged around said turret, including at least a first station, a second station and a third station, these stations being used respectively for carrying out the operations of positioning the inserts in the cavities of the mold, injecting plastic material into the cavities of the mold and demolding the at least partially cooled objects, the device comprising separate injection means for each cavity.

In one embodiment, each cavity has stationary and separate forced means for closing, making it possible to apply pressure directly onto the cavities during the filling of said cavities.

In one embodiment, each cavity has separate compacting means installed on the turret.

In one embodiment, the compacting means are active means or passive means.

In one embodiment, each cavity has separate means for locking installed on the turret.

In one embodiment, a first station for carrying out the operations of positioning the inserts in the cavities of the mold comprises means for positioning in order to place the inserts in the cavities.

In one embodiment, a second station for injecting plastic material into the cavities of the mold comprises separate injecting means to fill the cavities.

In one embodiment, a third station comprises means for unloading.

In one embodiment the remaining stations are used to increase the cooling time or to carry out operations for monitoring or to carry out operations for actuating the molds or even to carry out operations on the inserts and/or the molded objects.

In one embodiment, the turret comprises a number of stations of between five and eight.

In one embodiment, the number of molds arranged on the turret is equal to the number of stations.

In one embodiment, the number of multi-cavity molds arranged on the turret is at least five and is preferably between five and eight.

In one embodiment, the invention relates to a method for injection overmolding carried out on an indexed rotary turret and comprising at least the following successive operations
positioning inserts into the cavities of the mold
closing the mold
locking the mold, separate forced closing of the cavities of the mold
separate start of the injection into each cavity
ending the injection
solidification of the gate
releasing the forced closing of the mold
starting the compacting
cooling
unlocking the mold, ending the compacting
opening the mold
unloading the molded objects.

In one embodiment, the operations of closing and opening the mold, compacting, cooling and unlocking are carried out during the rotation of the turret.

In one embodiment, the movement of opening and closing the mold comprises a radial translational movement relative to the axis of the turret in order to shift the two parts of the mold.

In one embodiment, the inserts are of the same type or of a different type.

In one embodiment, the inserts are blocked by the blocking means in the cavity of the mold, once positioned.

In one embodiment, the presence and the position of the inserts is monitored before the closing of the mold.

In one embodiment, the forced closing of the mold is carried out by stationary means when the mold is in the station for injecting.

In one embodiment, each cavity has forced means for closing.

In one embodiment, the injection is carried out without the occurrence of sprue.

In one embodiment, during the unloading, a monitoring is carried out on the molded objects.

In one embodiment, the monitoring is a monitoring of the quality or dimensions or appearance or a combination thereof.

In one embodiment, the monitoring is optical.

### BRIEF DESCRIPTION OF THE DRAWINGS

The present invention will be understood more clearly by means of the description of embodiments thereof and by the figures, in which

FIG. 1 illustrates a basic outline of the method and the device for injection overmolding comprising an indexed rotary turret;

FIG. 2 illustrates the principle of separate filling of the cavities viewed from the side in section;

FIG. 3 illustrates a partial lateral sectional view of the mold installed on the turret;

FIG. 4 illustrates the partial lateral sectional view of a mold for producing objects without sprue.

### DETAILED DESCRIPTION

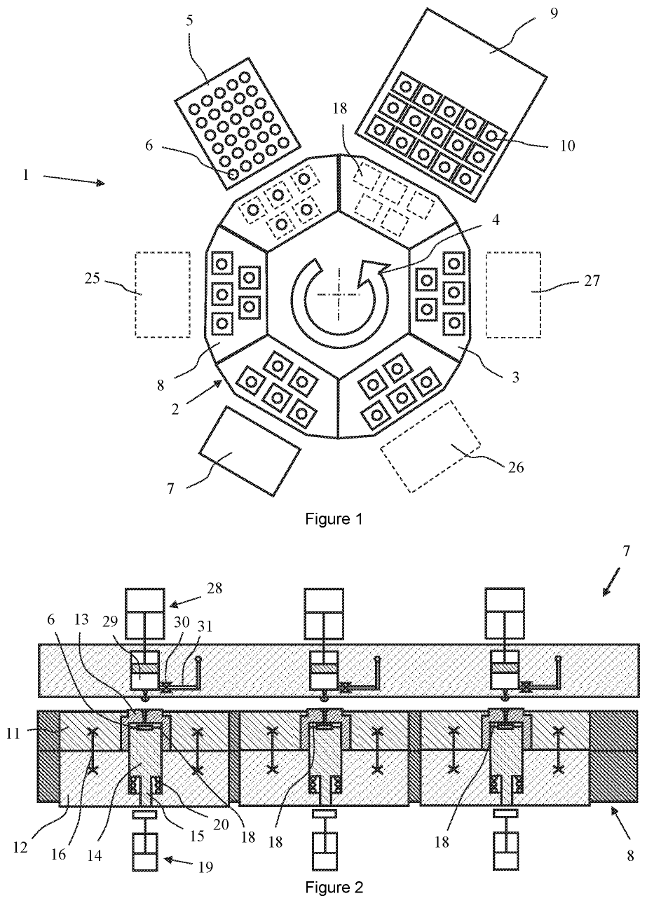

FIG. 1 illustrates an embodiment of the invention viewed from above. A turret 2 which is divided into a plurality of sectors 3 is set in indexed rotational motion 4. A mold 8 comprising a plurality of cavities 18 is fixed to each sector. Stationary stations 5, 25, 7, 26, 27 and 9 are arranged around the turret 2 and carry out operations in the molds 8 during the stoppage phase of the turret opposite said stations. The method and the device for overmolding illustrated in FIG. 1 permits the manufacture of overmolded objects at a high production rate.

The overmolding device 1 illustrated in FIG. 1 comprises six stationary stations (5, 25, 7, 26, 27 and 9) interacting with six molds 8 arranged on an indexed turret 2. Each mold 8 comprises five cavities 18. The station for loading the inserts 5 makes it possible to position the inserts 6 in the cavities of the mold 8. The following station 25 is used to monitor the position of the inserts 6 in the cavities 18 and to close the mold 8. The following station 7 serves to inject the plastic material into the cavities 18 of the mold 8. The two following stations 26 and 27 are used to cool and compact the molded objects 10 and/or to carry out the monitoring operations. Finally, the last station 9 permits the molded objects 10 to be demolded. According to a preferred embodiment, the turret comprises a number of between five and eight stations. Additional stations after the filling station 7 may make it possible, for example, to increase the cooling time of the objects 10 or carry out operations for monitoring the objects 10 or carry out operations on the molded objects, such as for example operations of assembly or printing or the like. As will be understood below, the device according to the invention is thus modular.

In order to permit the production of overmolded parts at a high rate, the molds 8 arranged on the turret comprise a plurality of cavities 18. According to the invention, the number of cavities per mold is between four and thirty two and preferably between four and sixteen. The maximum number of cavities 18 per mold 8 is based on the complexity of the handling and the overmolding of a high number of inserts 6.

In one embodiment, the overmolding cycle illustrated in FIG. 1 comprises the following successive operations:
positioning the inserts 6 in the cavities 18 of the mold 8 (station 5)
indexing, i.e. rotating, the turret by an angle corresponding to one sector
monitoring the position of each insert 6 in the cavities 18 (station 25)
closing the mold 8 (station 25)
indexing
locking and forced closing of the mold 8 (station 7)
separate filling of each cavity 18 (station 7)
solidification of the gate, then releasing the forced closing of the mold 8 (station 7)
indexing with cooling and compacting
cooling and compacting (station 26)
indexing with cooling and compacting
cooling and compacting (station 27)
indexing with unlocking of the mold and opening of the mold
unloading the molded objects 10 with their insert (station 9)
indexing of the open mold 8

A first feature according to an embodiment of the invention illustrated in FIG. 2 is located in the region of the station 7 and is that the number of shooting pots 29 is equal to the number of cavities 18 per mold 8. This means that during the injection phase each cavity of the mold 18 is connected to a separate shooting pot 29. This embodiment makes it possible to fill each cavity 18 separately from the adjacent cavities 18. The proposed filling method is particularly advantageous for overmolding inserts 6 at a high production rate.

The filling of each cavity 18 separately makes it possible to remedy the drawbacks of overmolding inserts 6 in a multi-cavity mold as explained above and below.

The invention makes it possible to remedy the drawbacks associated with the absence of an insert 6 from one of the cavities 18 at the moment of filling at the station 7. In particular, if an insert 6 is absent from one of the cavities 18 at the moment of injection, the cavity without the insert is not filled, without it having an impact on the quality of the parts 10 produced in the other cavities. In a conventional injection system where all of the cavities are filled simultaneously from a single shooting pot, the absence of an insert from one of the cavities results in the production of defective parts, since the filling of the mold bodies is no longer carried out evenly. Moreover, in a conventional injection system, the uneven filling of the mold bodies often causes difficulties in the ejection of the parts, which often causes stoppages in production in order to remove the incomplete parts manually from the mold. The invention makes it possible to remedy this loss of productivity.

According to the invention, a device for detecting the presence and the position of the inserts 6 in the cavities 18 of the mold 8 makes it possible to define the cavities to be filled during the injection operation. This device for detecting carries out the operation of monitoring after the positioning of the inserts and before the closing of the mold. In one embodiment illustrated in FIG. 1, a station 25 is added between the station 5 for loading the inserts and the station 7 for filling the cavities, in order to carry out this operation of monitoring the presence and position of the inserts 6. An alternative solution is to carry out the operation of monitoring the inserts during the indexing of the turret between the stations 5 and 7 without having an intermediate station 25. Preferably, the system for detecting is a visual device (optical, a camera or other equivalent) coupled to an image analysis module, for example installed on a computer. According to the invention, this module for detecting coupled with the separate filling of the cavities permits only cavities in which an insert 6 is present and correctly positioned to be filled. One advantage of the invention is that since the operations are carried out on an indexed rotary system, the detecting operation may, in particular, be carried out in masked time without this having an impact on the production rate of the machine.

A further advantage of the separate filling of the cavities is to permit the use of inserts 6 which are less accurate in terms of dimensions. The dimensional variations of the inserts may influence the volume occupied by each insert 6 in the cavity of the mold 8 This results in a variable volume of resin injected into each mold body 18. When the dimensional variations of the inserts are not negligible relative to the volume of material injected, in a conventional multi-cavity injection system, this results in an uneven filling of the mold bodies 18 and, as a result, significant dimensional variations on the molded objects 10 or the appearance of flash on the molded objects 10. Due to the separate filling of the cavities 18 the invention permits the use of less accurate inserts, whilst preserving a high level of accuracy in the region of the molded part of the object 10. In certain cases the use of less accurate inserts 6 makes it possible to reduce the cost of the parts 10 produced. The invention permits the problems of flash on molded objects to be remedied and thus the number of rejects to be reduced.

A further advantage of the separate filling of the cavities is associated with the rejection of inserts 6 which are poorly positioned in the cavity 18 of the mold 8. The separate injection of the cavities 18 coupled with the system for monitoring the position of each insert in the cavity of the mold makes it possible not to fill the cavities in which the positioning of the insert is out of tolerance. The alternative solution used in conventional systems consists in injecting the resin into all of the cavities and then ejecting the defective parts. This method generates significant wastage which is inherently difficult to recycle. The invention makes it possible to overcome this drawback. In numerous cases the ejected inserts 6 may be reused, otherwise the recycling thereof is facilitated since the overmolding operation has not taken place.

A further advantage of the separate filling of the cavities 18 is associated with the flexibility provided by this injection method. The invention makes it possible, for example, to produce molded parts of objects 10 of different mass in the same mold 8. Since the volume of material injected into each cavity is controlled separately for each pot, the accuracy of the volume injected is improved. This may be advantageous, for example, when different inserts are positioned therein.

The improved control of the volume of material injected into each cavity also makes it possible to reduce the closing forces of the mold. The closing force exerted by the forced means for closing 19 is reduced as a result. This results in a smaller dimensioning of the molds and, as a result, the mass installed on the turret is lower, which makes it possible to produce a higher production rate. An advantage which results therefrom is the reduction of energy required for the production of said objects.

The use of one shooting pot per cavity 19 also makes it possible to reduce the space taken up by the mold since the arrangement of the mold bodies in the mold may be optimized. The freedom of the number of mold bodies and their position in the mold is particularly useful in order to facilitate further operations such as the positioning of the inserts or the unloading of the objects.

A further advantage of the separate filling of the cavities 18 is associated with the possibility of eliminating sprue in the overmolded parts on indexed rotary systems.

The invention is particularly advantageous for overmolding fragile inserts 6 requiring the use of a low pressure and temperature of the resin injected during the filling of the cavities 8. The separate filling of the cavities permits an optimal reduction of the temperature and injection pressure.

A further advantage of the proposed overmolding device is associated with the short distance connecting the end of each shooting pot to the injection nozzle 21, illustrated in FIG. 4, which comes into contact with the mold die 13. The short length of the hot channel connecting the shooting pot to the injection nozzle 21 makes it possible to reduce the dwell time of the melt at a high temperature and limits the risk of damage associated with temperature, which makes these devices advantageous for transforming delicate plastic materials.

The embodiment of the device for overmolding illustrated in FIG. 2 comprises the station 7 for filling the cavities 18. This station 7 has forced means for closing the mold 8 in addition to injection means 28, 29 in order to fill separately the cavities 18 of the molds 8 in which the inserts 6 have been positioned. When the mold 8 is stopped opposite the station for injecting 7, the following operations are carried out:
forced closing of the mold, locking the mold and starting the filling of the molds 18,
ending the filling
solidification of the gate
releasing the forced closing of the mold.

The station for injecting 7 illustrated in FIG. 2 comprises one shooting pot 29 per cavity 18 of the mold 8. Each shooting pot 29 has injection means 28 which make it possible to inject the melt into the cavity 18. These injection means 28 may be electric, pneumatic or hydraulic. Each shooting pot 29 is also connected to an extruder by means of a hot channel 31 and a flap valve or solenoid valve 30. The role of the flap valve 30 is to permit the flow of the melt from the extruder to the shooting pot in order to fill said shooting pot 29 during the rotation of the turret 2 and to prevent the flow of melt from the shooting pot to the extruder during the injection phase.

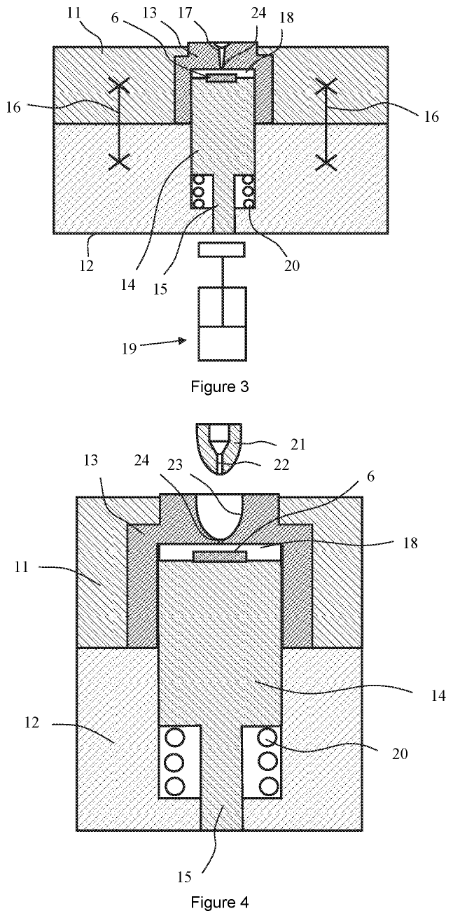

FIG. 3 illustrates the configuration of a part of the mold 8 at the moment of the passage of the mold in front of the station for injection overmolding 7. At the moment of the arrival of the mold at the station for injecting 7, the die block 11 forming the upper part of the mold and the punch block 12 forming the lower part of the mold are in the closed position, or in the approximately closed position, since the forced closing of the die block 11 against the punch block 12 has not been carried out. The forced closing is required to counter the opening force of the mold during the filling of the cavity 18. This resulting opening force is at a maximum when the cavity 18 of the mold is at the end of the filling procedure.

According to one embodiment of the invention, the method and device comprise forced means for closing the mold 8 which are stationary and act on the mold 8 when the mold is stopped in front of the station for injecting 7. According to a preferred embodiment of the invention illustrated in FIG. 2 and FIG. 3, each cavity 18 has stationary and separate forced means for closing 19 which is not connected to the turret 2. As illustrated in FIG. 2, the forced closing of the cavity 18 is carried out by mutually forcing the punch block 12 against the die block 11. Advantageously, the forced means for closing 19 exert a combined pressure on the punch end 15 connected to the punch 14. This action places under direct pressure the material contained in the cavity 18 formed between the punch 14 and the die 13. The forced means for closing 19 are, for example, electric, pneumatic or hydraulic actuators or a combination thereof.

Combined with its forced closing, the mold 8 is locked. This operation is illustrated by the means for locking illustrated in FIG. 3. In one embodiment, the invention is also characterized in that each mold 8 has separate means for locking 16. The separate means for locking 16 permits the cooling and compacting of the objects 8 to be performed outside the station for injecting 7. This embodiment is particularly advantageous since it permits the cycle time to be optimized and high production rates to be achieved.

Advantageously, these means for locking and unlocking 16 are installed on the turret 2 in order to permit the opening of the mold during the rotation of the turret 2.

The means for locking 16 permit the mold to be kept closed after the release of the forced means for closing 19 and during the rotation of the turret and the cooling of the object in the cavity 18 of the mold.

The means for locking 8 are composed of a lock and an energy accumulation mechanism. The lock is, for example, a hook system or an expansion system or even a deformation system. The energy accumulation mechanism makes it possible to maintain a significant closing force between the two parts of the mold during the cooling of the object. The energy accumulation mechanism is composed, for example, of mechanical springs or pneumatic springs or hydraulic springs. The actuation of the lock may be carried out by an actuator of the pneumatic, hydraulic or electric type. The actuation of the lock is either stationary or installed on the turret. Preferably, the actuation is installed on the turret in order to permit the unlocking of the mold during the rotation of the turret.

At the same time as the forced closing of the mold and the locking of the mold 8, the injection of melt into the mold is initiated. The simultaneous starting of the injection is made possible by the progressive increase in the pressure in the cavity of the mold and the approximately instantaneous forced closing of the cavity due to the forced means for closing 19. During the filling of the cavities 18, the forced means for closing 19 oppose the opening of the mold 8 and ensure the seal between the molds and the injection nozzles 21 coupled to the dies 13.

When the object is sufficiently cooled, the means for locking 16 unlock each cavity of the mold; the opening means then rapidly open the mold, this opening movement being able to comprise a radial shifting of the die block or the punch block in order to facilitate access to the objects contained in the mold. Since all of these means are installed on the turret 2, all of these operations may be carried out during the rotation of the turret 2. The opening means are, for example, pneumatic actuators, electric actuators or even hydraulic actuators.

Once the cavity 18 is filled, the object starts to cool since the punch block 12, the punch 14, the die block 11 and the die 13 forming the mold are cooled. This results in the solidification of the injection gate 24 which separates the molded object from the supply channel. The size of the supply gate 24 has a great influence on the production rate of the overmolding device 1. More specifically, before the solidification of the gate 24 it is necessary to maintain the injection pressure in the cavity 18, which prevents the rotation of the turret 2 and as a result increases the cycle time. It is thus very advantageous for the solidification of the gate to take place rapidly after the filling of the mold body 18. To permit the rapid solidification of the gate, it has been found that the diameter of the gate has to be between 0.3 and 0.8 mm and preferably between 0.4 and 0.6 mm. It is important to emphasize that the injection nozzle 21 which constitutes the end of the hot block comes into contact with the cooled die 13. The optimization of the contact time between the cold part and the hot part is necessary to solidify the gate 24 located in the die whilst avoiding the formation of a cold slug in the nozzle 21 in the region of its end 22. The dimensioning of the supply channel 22 of the nozzle 21 is important to avoid the formation of a cold slug.

When the gate is solidified, the pressure exerted on the mold by the forced means for closing 19 is relaxed. The forced closing actuators release the punch holder and 12 and the punch end 15. The release of the forced closing of the tool also causes the separation of the injection nozzles 21 and the dies 13. The mold 5 then becomes disconnected from the station for injecting 7 which permits the rotation of the turret 2.

An inherent difficulty with rotary molding devices is in the reduction of sprue 17 which has to be detached from the object and recycled. An advantage of the invention is to permit the reduction of the volume of this sprue 17.

According to a preferred embodiment illustrated in FIG. 4, the injection is carried out without the occurrence of sprue 17. The injection nozzle 21 connected to the hot block comes into contact with the nozzle receptacle 23 of the die 13. The nozzle receptacle 23 is connected to the cavity via the gate 24. The geometry of the gate 24 is conical with a cylindrical part located on the side of the nozzle receptacle and forming the smallest flow cross section. The optimization of the end 22 of the injection nozzle 21 and the nozzle receptacle 23 makes it possible to obtain a seal between the hot part and the cold part of the injection device.

The objects 10 are then cooled in the mold 8. FIG. 1 illustrates a device comprising two cooling stations 26 and 27. When the object cools in the cavity of the mold, the volume of the object is reduced due to the change in state and the reduction in temperature of the material. In order to prevent the reduction in volume causing defects in the object, it is thus necessary to continue to exert a pressure on the material contained in the cavity of the mold.

In one embodiment, the compacting means 20 are separate from the injection unit 7. The phase of compacting makes it possible, in particular, to avoid shrink marks in the molded objects 10 or to improve the dimensional stability and the accuracy of said molded objects 10.

According to one embodiment of the invention, preferably each cavity 18 has separate compacting means 20 installed on the turret. Thus the number of compacting means 20 is equal to the total number of cavities 18 on the turret 2, i.e. the number of cavities per mold multiplied by the number of molds on the turret. According to the invention, the number of compacting means 20 per mold 8 is between four and thirty two and preferably between four and sixteen.

An advantage of the invention is associated with the fact that the compacting means 20 are installed on the turret 2. This makes it possible to maintain a pressure on the injected resin during the entire cooling of the object in the mold. The fact that the compacting means 20 are installed makes it possible to maintain the pressure on the injected resin without having a negative impact on the production rate.

According to one embodiment of the invention, each cavity 18 has separate compacting means. These compacting means 20 are composed of at least one mobile tool entering the cavity and exerting a pressure on the injected resin, in addition to a compacting element which is connected to the mobile tool part.

Preferably, the compacting element is a passive element such as a spring. According to our invention, the compacting element accumulates energy during the filling of the mold body when the cavity is connected to the shooting pot (compression of the spring). A part of the energy accumulated during the filling phase is then restored by the compacting element during the cooling of the object (decompression of the spring). The passive compacting element may be a steel spring or an air spring.

According to an alternative method, the compacting element is an active element such as an actuator. The active compacting element makes it possible to control the compacting pressure over time, but increases the inertia installed on the turret.

A further advantage of the invention is associated with the fact that the compacting phase is no longer limited by the time for the solidification of the injection gate 24, as is the case with the devices of the prior art. With these devices of the prior art, a significant disparity is observed in the time for the solidification of the gate 24 of each mold body 18, which results in creating variations between the molded objects 10. The invention permits these difficulties to be remedied. The invention permits a compacting pressure to be exerted on the molded object 10 during the cooling of said object and after the solidification of the injection gate 24. This results in an improved dimensional accuracy of the objects 5, in addition to a less significant disparity between the objects 10 which emerge from the different cavities 18.

The separate compacting means 20 makes it possible to optimize the pressure exerted during the cooling phase for each cavity 18. This permits, in particular, the use of less accurate inserts 6 or objects 10 of different volumes to be molded without compromising the quality of said objects obtained.

The invention is particularly advantageous for the overmolding of fragile inserts 6 requiring the reduction of pressure on the insert 6 during the overmolding operation. The separate compacting means 20 for each cavity 18 permits an optimal reduction of the compacting pressure on the overmolded inserts 6.

FIG. 3 illustrates a partial view of the mold 8 installed on the turret. The mold 8 comprises for each cavity 18 compacting means 20 in the form of a spring, making it possible to compress the material contained in the cavity 18. According to the preferred embodiment, each cavity 18 has passive compacting means 20 which permit, if required, different parts to be produced in each cavity.

The present invention permits the opening and closing of the mold 8 during the rotation of the turret 2 in order to optimize the cycle time. According to one embodiment, the device comprises means for opening and closing installed on the turret 2. These means take up little space and are rapid due to the low mass of the molds 8.

Following the positioning of the inserts 6 in the cavities 8, the mold 5 is closed. The closing operation may be carried out when the turret stops or during the rotation of the turret. Advantageously, this operation is carried out in masked time during the rotation of the turret 2 due to the means for opening and closing installed on the turret 2. The closing operation does not require significant force due to the low mass of the mold 5. Each mold 5 has separate and rapid means for opening and closing. These means are, for example, of the mechanical, pneumatic or even hydraulic type, or a combination thereof.

The invention makes it possible to reduce the complexity of robotic operations. These robotic operations are useful, in particular, on the station for loading the inserts 6 in order to position simultaneously a plurality of inserts 6 in the mold 8. The proposed method for injection overmolding makes it possible to reduce by a factor of 4 to 10 the number of inserts 6 handled simultaneously relative to a conventional injection method having the same number of cavities. This is in addition to the fact that the mold 8 arrives open from the station for unloading 9 which makes it possible to arrange stationary insertion means between the upper part and the lower part of the mold 8. According to a preferred embodiment of the invention, the upper or lower part of the mold 8 combines a perpendicular movement with an opening movement in order to release the upper part from the lower part and facilitate the handling in the mold. This perpendicular movement, preferably along the radial axis of the turret 2, permits the handling of bulky inserts 6 and facilitates the optional operations of monitoring, assembly, welding or printing in the mold 8. The operations of unloading the objects 10 are also considerably facilitated.

The method of overmolding comprises at least one first step of positioning the inserts 6 in the cavities 18 of the mold. The transfer of the inserts 6 into the cavities 18 is carried out by means of a first station 5 provided with positioning means. The positioning means are highly diverse and depend on the type of insert, its shape and its dimensions. Robotic means are present, said robotic means, due to the combination of translational and rotational movements, permitting the objects to be displaced from a point A to a point B. These robotic means which are frequently used in conventional injection molding, in order to load or unload the objects in the multiple-mold-body molds, may also be used within the scope of the invention. However, it is very advantageous to use less complex robotic means by reducing the number of translational and rotational movements in order to position the inserts 6 in the cavities 18 of the molds 8.

The indexed rotary method illustrated in FIG. 1 permits the simplification of the positioning means since a reduced number of inserts is handled simultaneously for an identical production rate. For example, in a conventional injection mold comprising 48 cavities, the positioning means of the inserts have to control 48 inserts simultaneously. With a turret 1 comprising 6 sectors, only 8 inserts instead of 48 are positioned simultaneously. A further factor for simplifying the positioning means of the inserts 6 is associated with the fact that the mold 8 arrives in the open position at the station 5 for loading the inserts 6. It is thus often possible to position the handling means in the space formed by the opening of the mold 8.

According to a preferred embodiment of the invention, the opening movement of the mold also comprises a radial translational movement relative to the axis of the turret, which has the effect of shifting the upper part and the lower part of the mold. The access to the cavities 18 for the loading of the inserts is thus facilitated. Simpler loading means may thus be used.

The invention facilitates the overmolding of a label or functional film. According to the usual methods of overmolding, a first step is to cut out the labels from a film and then package the labels into packages, possibly storing them. For the manufacture of overmolded objects the labels are transferred to the injection assembly. A robot then handles the labels in order to position them accurately in the multi-cavity molds. A preferred embodiment of the invention for this type of object is to cut out and position the film directly in the injection mold 8. According to this preferred embodiment, the means of positioning the insert in the mold comprise a first step of unwinding the film, a second step of stamping and positioning the labels and a third step of unwinding the remainder of the film. According to the invention, the operation of stamping and positioning the label is carried out directly in the cavities 18 of the molds 8. The axial shifting of the upper and lower part of the mold facilitates this stamping and positioning operation. This operation of cutting out labels directly in the mold makes it possible to guarantee a high level of accuracy of the positioning of the labels in each cavity and simplifies the robotic operations.

The device illustrated in FIG. 1 comprises a single station 5 for loading inserts 6. For objects requiring a plurality of inserts, it may be advantageous to have one or more additional stations for positioning, especially when the inserts are of a different shape and geometry. Thus a first station will be used to position a first type of insert and a second station for a second type of insert. This principle may naturally be repeated if additional types of inserts have to be positioned.

The molds 8 advantageously comprise means for blocking the inserts in the cavity of the mold during the closing of said molds, during the rotation of the turret and during the injection of the melt. These blocking means may be created by suitable dimensional tolerances between the object and the mold body or by suction means or by mechanical means or by electrostatic means or even by magnetic means or further equivalent means. The blocking means are selected as a function of the nature of the insert and the blocking forces required.

The injection overmolding device illustrated in FIG. 1 comprises at least one station for unloading 9 which has means for extracting the objects 10 from the mold 8 and positioning the objects on a conveyor or a further device. The means for unloading are very diverse and depend on the type of object, its shape and its dimensions. Robotic means are present, said robotic means, due to the combination of translational and rotational movements, permitting the objects to be displaced from a point A to a point B. These robotic means which are frequently used in conventional injection-molding for loading or unloading the objects in the multiple-mold-body molds may also be used within the scope of the invention. However, it is very advantageous to use less complex robotic means, by reducing the number of translational and rotational movements to unload the objects 10. The method and device 1 permit the simplification of the means for unloading since a reduced number of objects is handled simultaneously for an identical production rate. A further factor for simplifying the means for unloading the objects is associated with the fact that the mold 8 may arrive in the open position at the station for unloading 9 the objects. It is thus often possible to position the handling means in the space formed by the opening of the mold 8. When the opening movement of the mold 8 also comprises a radial translational movement relative to the axis of the turret, which has the effect of shifting the upper part and lower part of the mold, the access to the cavities for the unloading of the objects 10 is facilitated. As a result, simpler means for unloading may be used.

It is advantageous during the demolding of the objects 10 to preserve their orientation in order to facilitate the additional operations which then have to be carried out. It is advantageous, for example, to make use of the station for unloading 9 to carry out monitoring of the objects 10. Monitoring of the dimensions or appearance carried out via optical means may be easily incorporated in the station for unloading 9.

In the embodiments, the device for injection overmolding 1 may comprise optional stations 25 shown in dotted lines in FIG. 1. These optional stations illustrate the modularity of the proposed device. The optional stations may consist in carrying out a monitoring operation of the object which is located in the cavity of the mold; or a printing operation of the object; or even an assembly operation; or even a further molding operation. It is important to note that these operations are made possible, in particular, by the means for opening and closing the mold, in addition to the means for locking-unlocking the mold, being installed on the turret.

The invention permits the optional addition of further stationary stations around the indexed rotary turret 2. The invention permits, for example, the addition of a station for monitoring the presence and the position of an insert 6 in each cavity 18.

Further stations may be added, such as for example stations for printing, assembly, dimensional monitoring or welding.

The embodiments of the present invention are provided by way of example and should not be considered as limiting. Variants are possible within the scope of the claimed protection, in particular by using equivalent means. The various embodiments which have been described may also be combined together.

### REFERENCE NUMERALS

1: Device according to the invention
2: Turret
3: Sector
4: Indexed rotational movement
5: Station for loading the inserts
6: Insert
7: Station for injecting
8: Mold
9: Station for demolding
10: Molded object
11: Die block
12: Punch block
13: Mold die
14: Punch
15: Punch end
16: Means for locking
17: Sprue
18: Cavity
19: Forced means for closing
20: Compacting means
21: Injection nozzle
22: End of injection nozzle
23: Nozzle receiver
24: Injection gate
25: Station for monitoring the inserts
26: Station for cooling and compacting or monitoring
27: Station for cooling and compacting or monitoring
28: Injection means
29: Shooting pot
30: Flap valve or solenoid valve
31: Hot channel

1-24. (canceled)

25. An injection overmolding device for forming molded objects comprising:
an indexed rotary turret having a plurality of cooled molds, each cooled mold including a plurality of cavities;
an injection device for each cavity; and
a plurality of operational stations arranged around the indexed rotary turret,
wherein the plurality of operational stations include,
a first operational station for positioning an insert into at least some of the cavities of one of the plurality of the cooled molds,
a second operational station for injecting plastic material into at least some of the cavities of one of the plurality of the cooled molds having the inserts for forming the molded objects with the inserts, and
a third operational station for removing the at least partially cooled and molded objects with the inserts formed in the least some of the cavities.

26. The device as claimed in claim 25, wherein each cooled mold includes a device for locking the cooled mold to the indexed rotary turret.

27. The device as claimed in claim 25, wherein each cavity includes a device for closing the cavity to apply a pressure directly to the cavity during the injecting of the plastic material by the second operational station.

28. The device as claimed in claim 25, wherein each cavity includes a separate compacting device installed on the indexed rotary turret.

29. The device as claimed in claim 28, wherein the compacting device includes an active or a passive mechanism.

30. The device as claimed in claim 25, wherein the first operational station includes a positioning device for placing the inserts into the respective cavities.

31. The device as claimed in claim 25, wherein the second operational station includes a separate injection device for filling the cavities.

32. The device as claimed in claim 25, wherein the third operational station includes an unloading device.

33. The device as claimed in claim 25, wherein another operational station of the plurality of operational stations is configured to perform at least one of increasing a cooling time, carrying out operations for monitoring, carrying out operations for actuating the molds, carrying out operations on the inserts, and carrying out operations on the molded objects.

34. The device as claimed in claim 25, wherein the indexed rotary turret includes between 5 and 8 operational stations.

35. The device as claimed in claim 25, wherein a number of molds arranged in the indexed rotary turret is equal to a number of operational stations.

36. The device as claimed in claim 25, wherein the number of molds arranged in the indexed rotary turret is at least 5.

37. A method for injection overmolding carried out on an indexed rotary turret, the method comprising the steps of:
positioning prefabricated inserts into the cavities of the mold;
closing the mold;
locking the mold by a separate forced closing mechanism to the cavities of the mold;
injecting a plastic material into each cavity;
solidifying a gate;
blocking an injection threshold;
releasing the forced closing mechanism of the mold;
compacting the mold;
cooling the mold;
unlocking the mold and ending the compacting of the mold;
opening the mold; and
unloading the molded objects including the inserts from the mold.

38. The method as claimed in claim 37, further comprising the step of:
rotating the indexed rotary turret,
wherein the steps of closing and opening the mold, compacting, cooling and unlocking are carried out during the step of rotating.

39. The method as claimed in claim 37, wherein the steps of closing and opening the mold include a radial translational movement relative to an axis of the indexed rotary turret to shift two parts of the mold.

40. The method as claimed in claim 37, further comprising the step of:
blocking the inserts by a blocking device in the cavities of the mold after the step of positioning inserts into the cavities of the mold.

41. The method as claimed in claim 37, further comprising the step of:
monitoring a presence and a position of the inserts before the step of closing of the mold by force.

42. The method as claimed in claim 37, wherein the forced closing of the mold is carried out by a stationary device when the mold located at the second operational station for the step of the injecting the plastic material.

43. The method as claimed in claim 37, wherein each cavity has device for forced closing to perform the step of closing the mold.

44. The method as claimed in claim 37, wherein the step of injecting is carried out without a sprue.

45. The method as claimed in claim 37, further comprising a step of:
monitoring the molded objects during the step of unloading.

46. The method as claimed in claim 45, wherein the monitoring monitors at least one of a quality, a dimension, and an appearance of the molded object.

47. The method as claimed in claim 45, wherein the step of monitoring included an optical measurement.

48. The device as claimed in claim 25, wherein the inserts include inserts of a same type or of a different type.
